(19) United States
(12) Patent Application Publication
(10) Pub. No.: US 2013/0162387 A1
(43) Pub. Date: Jun. 27, 2013

(54) THERMAL CUTOFF LINK SAFETY FUSE IN HVAC SYSTEM

(71) Applicant: Roy Kelley, Miami, FL (US)

(72) Inventor: Roy Kelley, Miami, FL (US)

(21) Appl. No.: 13/334,418

(22) Filed: Dec. 22, 2011

(51) Int. Cl. H01H 85/00

(52) U.S. Cl. 337/142

(57) ABSTRACT

The present invention relates to a thermal cut off link safety fuse for use in a HVAC system. The thermal cut off link safety fuse disconnects the electrical circuit from the HVAC system's heating element when the thermal cut off link safety fuse melts upon reaching a temperature that exceeds a set temperature. The use of the thermal cut off link safety fuse in a HVAC system helps prevent fires caused by blocked airflow, insufficient airflow or excessive heat within the HVAC system

### TECHNICAL FIELD

The present invention relates to a thermal cut off link safety fuse for use in a HVAC system. The thermal cut off link safety fuse disconnects the electrical circuit from the HVAC system's heating element when the thermal cut off link safety fuse melts upon reaching a temperature that exceeds a set temperature. The use of the thermal cut off link safety fuse in a HVAC system helps prevent fires caused by blocked airflow, insufficient airflow or excessive heat within the HVAC system.

### BACKGROUND OF THE INVENTION

Currently, the over-temperature or overheat protection devices used in HVAC systems are the same over-temperature protection devices commonly used in electric heaters. As used herein, the term “HVAC systems” includes heating, ventilation, air conditioning systems and related duct work. Most of the overheat protection devices used in the HVAC systems are not fail-safe mechanisms.

In general, electrical systems often include components such as circuit breakers to protect circuit elements from electrical overloads. A conventional circuit breaker includes a conductor element with a current rating. The current rating identifies the maximum amount of current that can pass through the circuit breaker without the device activating. Once the maximum current is reached or exceeded, the mechanism in the circuit breaker activates, opening a set of contacts which interrupts the flow of electric power, thus protecting other equipment from elevated current levels.

Over periods of time, traditional electrical devices employed in HVAC systems may fail in the “closed” mode. This may be caused by melting and welding of contact points or by mechanical failure. In such a failure mode, the devices will fail to open when an over-voltage or over-current condition is present and expose other components to dangerous electrical loads. This could lead to damage to electrical components and/or excessive temperatures which could, in turn, lead to catastrophic fires.

One of the most common causes of failure in traditional electrical overload devices is overvoltage. Overvoltage is considered a safety hazard by all industry standards, and can cause premature failure of connected equipment. Instances of severe cold weather during the heating seasons can cause power company protection devices to trip off power (serving a number of distribution zones) due to overloads. The sudden load losses can cause voltage to suddenly increase above the limit at points of use in the distribution systems that remain on-line. Overvoltage can cause damage to electrical equipment of all types, including HVAC equipment, circuit boards, relays, and reversing valves. Any of this damage can result in a fire.

Most traditional, thermal over-temperature devices are not fail-safe because they can fail to open the electrical circuit to the heating element(s), and allow unchecked over-heating to surrounding materials which over-heat and cause fire.

Another safety component often used in electric heaters is the automatic reset temperature limiter. This is an electro-mechanical device that detects temperature changes and mechanically disconnects power when a temperature, rather than an electrical current, limit is reached. These devices reset themselves automatically once temperatures return to normal. These devices are not considered fail-safe and can fail in the closed position, with the contacts welded together. This can occur due to excessive on-off cycling of the device when the incoming utility voltage exceeds the legal limits and/or when the indoor system airflow is less than the minimum requirements. These conditions usually go unnoticed by occupants, uncorrected by technicians and may develop over years leading to an inevitable catastrophic failure and likely a fire.

Low airflow exists in more than 50% of heat pump systems in the United States. Low airflow causes auxiliary electric heaters to short-cycle by their auto-reset primary high temperature safety limits and become inoperative by their secondary back-up safety limits. It is also widely known that low airflow will cause heat pump compressors to short-cycle by their auto-reset high head pressure limits. Both the electric heater and the compressor are subject to premature failure depending on the degree of low airflow and the length of time in use.

Some electric heaters and heat exchangers such as water heaters and air heating apparatuses, detect the temperature with a temperature sensor for temperature control. These devices are provided with an electronic temperature control unit to stop current or combustion when the detected temperature has exceeded a target temperature. However, there is a possibility that such temperature control unit operates abnormally due to a failure in the logic or the electronic components of its internal control circuit.

As summarized above, the biggest disadvantage in the existing HVAC overheat protection technology is that it either relies on detecting elevated current or voltage levels in the circuits powering the system or, if it detects elevated temperatures, it is not fail-safe. As explained above, an overheat condition could develop without excess current or voltage in the circuits in the case of low airflow. Under such conditions, excess heat could accumulate in vents and ducts and because no excess current or voltage is detected, the system would continue to generate heated air making the risk of fire even greater.

Existing overheat protection technology which relies in direct temperature measurements, e.g., automatic reset temperature limiters and electronic temperature control units, is disadvantageous in that they are complicated and prone to failure because of the multiple parts required to operate them. Moreover, these technologies are not fail-safe and can therefore fail without providing warning to the user, leaving the HVAC system open to catastrophic fire damage.

Accordingly, there is a need in the art for an HVAC temperature protection device which is simple, reliable, and fail-safe and which relies on direct temperature sensing rather than indirect measurements such as over-current or over-voltage situations.

Another big disadvantage of current systems is the failure of over-temperature or overheat protection devices in a HVAC system when the air flow is restricted or blocked.

Thus, there is a need for a system that can protect from failure due to heat created when the air flow is restricted or blocked.

There is a further need in the art for a fail-safe thermal fuse that is lower in cost than other non-fail-safe devices currently utilized.

There is also a need for a fail-safe device that can be easily and readily removed and replaced without the need to remove the heater assembly from the HVAC ductwork or HVAC system.

### SUMMARY OF THE INVENTION

The current invention satisfies the needs in the industry by providing a thermal cut off link safety fuse for use in HVAC systems. The thermal cut off link safety fuse is comprised of a terminal block, two double-sided electrical terminals mounted on the terminal block, and a length of conductive heat-sensitive fuse element which is electrically connected to one side of each of the terminals.

The thermal cut off link safety fuse is installed by electrically connecting its two open terminals in series with the heater coil circuit of the HVAC system and placing it within the airflow where heat detection and cutoff is desired. As the airflow heats up and exceeds the temperature rating of the device, the fuse element in the device melts and the current flow to the heater coil is interrupted, this preventing the continued heating of airflow and reducing or eliminating the risk of fire.

It is therefore an object of the present invention to provide for an HVAC temperature protection device which is simple, reliable, and fail-safe and which relies on direct temperature sensing rather than indirect measurements such as over-current or over-voltage situations.

It is a further object of the present invention to provide a system that can protect from failure due to heat from fire and heat created when the air flow is blocked.

It is a further object of the present invention to provide a fail-safe thermal fuse that is lower in cost than other non-fail-safe devices currently utilized.

It is a further object of the present invention to provide a fail-safe device that can be easily and readily removed and replaced without the need to remove the heater assembly from the HVAC ductwork or HVAC system.

These and other objects, features, and advantages of the present invention may be more clearly understood and appreciated from a review of ensuing detailed description of its various embodiments and by reference to the accompanying drawings and claims.

### BRIEF DESCRIPTION OF THE DRAWINGS

FIG. 1A is an exploded view of the thermal cut off link safety fuse of the present invention.

FIG. 1B is an assembled view of the thermal cut off link safety fuse of the present invention.

FIG. 2 is an electrical schematic of the thermal cut off link safety fuse when connected to a heating element.

FIG. 3 is a diagram showing the thermal cut off link safety fuse when used in a forced airflow heating system.

### DETAILED DESCRIPTION

While the present invention will be described more fully hereinafter with reference to the accompanying drawings, in which one or more embodiments of the present invention is shown, it is to be understood at the outset of the description which follows that persons of skill in the appropriate arts may modify the invention herein described while still achieving the favorable results of this invention. Accordingly, the description which follows is to be understood as being a broad, teaching disclosure directed to persons of skill in the appropriate arts, and not as limiting upon the present invention.

The current invention satisfies the needs in the industry by providing a thermal cut off link safety fuse for use in HVAC systems. The thermal cut off link safety fuse is comprised of a terminal block, two double-sided electrical terminals mounted on the terminal block, and a length of conductive heat-sensitive fuse element which is electrically connected to one side of each of the terminals.

The fuse has no contacts and positively disconnects the electrical circuit in a fail-safe manner by melting its fuse element when air flow temperature exceeds the maximum safe operating temperature.

The thermal cut off link safety fuse disconnects the electrical circuit to the heating element(s) and prevents over-heating. Various melting temperatures of the alloy metal link are used in the thermal cut off link safety fuse depending on the particular application.

In one embodiment of the invention a fail-safe thermal cut off link safety fuse is employed in an HVAC system, whereby the thermal cut off link safety fuse can easily be removed and replaced without the need to remove the heater assembly from the HVAC ductwork or HVAC system. The two-sided terminals of the thermal cut off link safety fuse are secured into an insulating terminal block, such as a ceramic assembly, with screws so that the thermal fuse may be removed and replaced without the need to remove the entire heater from the HVAC ductwork or HVAC system.

The invention provides a thermal cut off link safety fuse assembly for use in a HVAC system comprising a thermal cut off link safety fuse, a heating element, and at least one electrical connection connecting the heating element to a line voltage. The assembly is removably secured into an insulating substrate and housed in a sheet metal or other temperature resistant enclosure. The thermal cut off link safety fuse disconnects the line voltage from the heating element when the thermal cut off link safety fuse melts upon reaching a temperature that exceeds a set temperature thereby shutting down the HVAC system and preventing fires caused by blocked airflow, insufficient airflow or excessive heat.

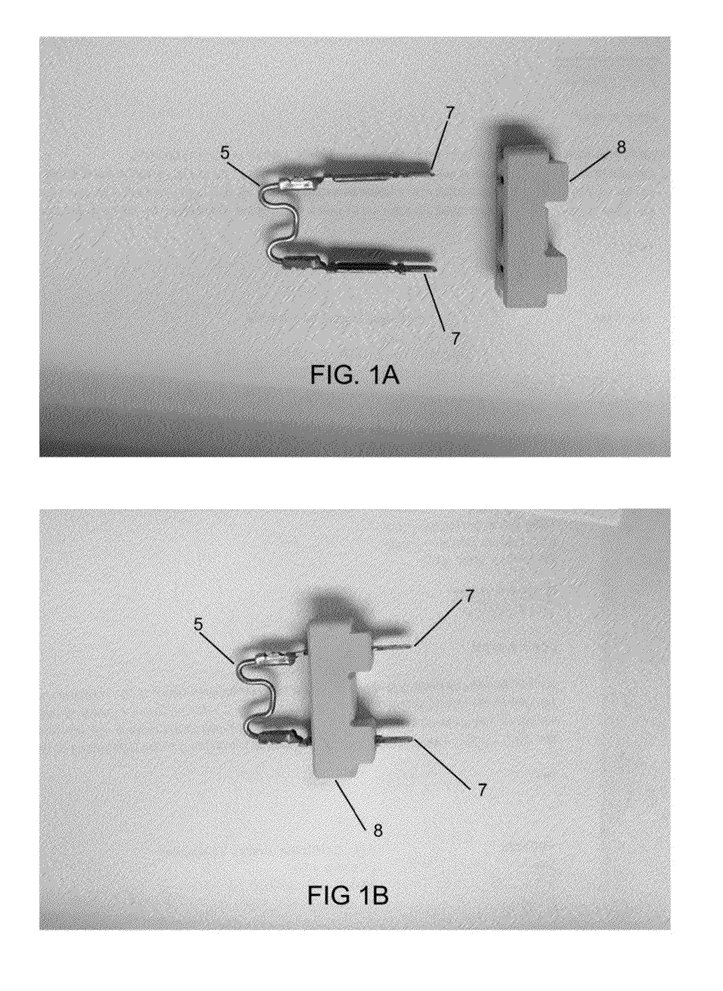

Referring first to FIG. 1A and 1B, shown respectively are exploded and assembled views of the disclosed devise. Shown are the electrical connectors 7, ceramic insulator 8, and the safety heat fuse element 5, all of which are discussed in further detail below.

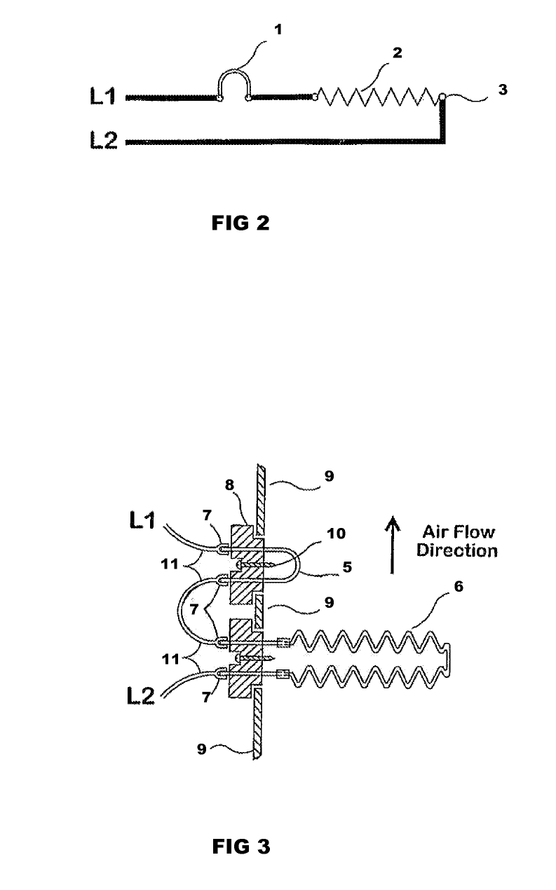

Referring now to FIG. 2 illustrated is an electrical schematic showing use of a thermal cut off link safety fuse 1, herein also referred to and abbreviated as “TCOL” safety fuse 1. The electrical schematic shows an electric resistance heating element 2 connected to a line voltage source 4 which may be controlled by a thermostat or switch to maintain a desired room temperature. The heating element 2 is connected to the line voltage 4 by an electrical connection 3. The thermal cut off link safety fuse 1 disconnects the circuit to the heating element 2 when the ambient temperature of the TCOL safety fuse 1 rises above a maximum allowable temperature for safe operation due to insufficient airflow over the heating element 2. The TCOL safety fuse 1 has no contacts and disconnects the circuit to the heating element 2 in a fail safe manner by melting away when the ambient temperature proximal to the heating element 2 exceeds the maximum safe operating temperature.

FIG. 3 is a diagram showing the thermal cut off link safety fuse or TCOL safety fuse 5 when used in forced airflow heating systems. The TCOL safety fuse 5 is mounted in a ceramic insulator 8 which is installed with screws 10 in a sheet metal enclosure 9 which houses the heating element(s) 2. Electrical connections are made with insulated wire 11 and electrical connectors 7. The TCOL safety fuse 5 melts and disconnects the heating elements 6 when the reduction, or absence, of airflow causes the ambient temperature proximate to the TCOL safety fuse 5 to rise above unsafe levels. The TCOL safety fuse 5 may be removed and replaced by removing the screws 10 of the ceramic insulator 8 assembly without the needs to remove the entire heater from the ductwork or equipment housing.

It will be understood that the length, thickness and material of the safety fuse 5 can be varied depending on the electrical load that must be handled by the HVAC system, and the desired maximum temperature before the fuse melts. Suitable materials for the safety fuse 5 include any conductive metals with a relatively low melting temperature (e.g. solder wire) such as, but not by way of limitation: tin, lead, copper, silver, gold, zinc, bismuth and alloys thereof.

Accordingly, it will be understood that the preferred embodiment of the present invention has been disclosed by way of example and that other modifications and alterations may occur to those skilled in the art without departing from the scope and spirit of the appended claims.

What is claimed is:

1. A thermal cut off link safety fuse assembly comprising:
a. a thermal cut off link safety fuse having first and second fuse terminals;
b. a heating element having first and second heating element terminals;
c. said first fuse terminal being electrically connected to said first heating element terminal;
d. said second fuse terminal and said second heating element terminal each being electrically connected to opposed polarity electrodes of a power source;
e. wherein said thermal cut off link safety fuse melts upon reaching a designated temperature, interrupting electrical continuity between said electrodes of said power source, and terminating electrical current flow through said heating element.
